(19) United States
(12) Patent Application Publication
(10) Pub. No.: US 2017/0004225 A1
(43) Pub. Date: Jan. 5, 2017

(54) INTEGRATED COMPUTER-AIDED DESIGN OBJECT CLASSIFICATION

(71) Applicant: General Electric Company, Schenectady, NY (US)

(72) Inventors: James Daniel Antalek, Schenectady, NY (US); Raymond G. Zakrwski, Greenville, SC (US); Celeste Liverio, Schenectady, NY (US); Sridhar Ramireddy, Greenville, SC (US); Shinoosh McAuliffe, Cincinnati, OH (US); Sreekanth Mandalamane Earegowda, Bangalore (IN)

(21) Appl. No.: 14/789,777

(22) Filed: Jul. 1, 2015

(51) Int. Cl. G06F 17/50; G06F 21/62; G06F 17/30

(52) U.S. Cl. CPC G06F 17/50; G06F 17/30598; G06F 21/6218

(57) ABSTRACT

Provided herein are techniques and systems for seamless integration of PLM system functionalities, such as classification and/or attribute association, to a computer-aided design (CAD) system. An integration module provides integration of product lifecycle management (PLM) system functionalities with a CAD system. Specifically, using the techniques and systems described herein, classification and/or attribute associations with CAD objects may be facilitated directly from the CAD system.

### BACKGROUND

The subject matter disclosed herein relates to the field of computer-aided design (CAD) and, more particularly, to systems and methods for integrated classification and/or product lifecycle management of CAD objects within a CAD system.

A number of systems and systems are offered on the market for the design of parts or assemblies of parts. Computer-aided design (CAD) systems allow designers to construct, manipulate, and/or view two-dimensional and/or three-dimensional drawings, objects, and/or assemblies of drawings and/or objects. CAD systems may include graphical tools for creating and/or representing these CAD drawings and/or objects.

In some situations, especially in enterprise work environments, a multitude of designers, engineers, etc. may work with one or more drawings, models, and/or assemblies of the CAD system. Product life cycle management (PLM) systems may facilitate organization of product engineering knowledge, manufacturing engineering knowledge, and/or enterprise integrations. For example, the PLM system may facilitate the linking of products, processes, resources, etc. to enable knowledge-based product creation and decision-making.

The PLM systems may be used to classify and/or attribute characteristics to one or more drawings, models, and/or assemblies of the CAD system. For example, certain components of an assembly may be classified with one of a multitude of security classifications, such as Class I: Public, Class II: Internal Company Access, and/or Class III: Internal Company Access for particular personnel, etc. Further, access authority attributes may be assigned to the drawings, models, and/or assemblies. For example, access rights may be attributed to one or more CAD files (e.g., drawings, models, and/or assemblies) based upon the classifications of the files. Further, these files may be classified as part of a particular subset of an over-arching assembly (e.g., a component of a generator of a gas turbine system, etc.).

In some situations, access, modification, and/or use of the drawings, models and/or assemblies may depend on classification and/or the attributes of the drawings, models, and/or assemblies. For example, gasification engineers may only have access to CAD files that are classified or attributed as gasification portions of the turbine system.

Unfortunately, PLM systems have traditionally been separate from the CAD systems, utilizing copies of CAD objects transferred to the PLM systems to separately manage the PLM aspects of a project. Such separation of the PLM systems and the CAD systems has resulted in classification and/or attribute designation delays, lost development time and/or access, and other costly issues. Therefore, it would be beneficial to improve CAD system integration with PLM systems, especially during creation, modification, and/or access of CAD drawings, models, and/or assemblies.

### BRIEF DESCRIPTION

Certain embodiments commensurate in scope with the present disclosure are summarized below. These embodiments are not intended to limit the scope of the claims, but rather these embodiments are intended only to provide a brief summary of certain embodiments. Indeed, embodiments of the present disclosure may encompass a variety of forms that may be similar to or different from the embodiments set forth below.

In one embodiment, a system includes a computer-aided design (CAD) system. The CAD system includes a first processor, that executes a CAD application, wherein the CAD application includes processor-readable instructions stored on a first tangible, non-transitory, machine readable medium and a product lifecycle management (PLM) system. The PLM system includes a second processor, that executes a PLM application, wherein the PLM application includes processor-readable instructions stored on a second tangible, non-transitory, machine readable medium. A classification customization integration module, includes processor-readable instructions stored on a third tangible, non-transitory, machine readable medium, wherein the classification customization integration module receives data from the PLM application; and provides classification, attribute, or classification and attribute associations with a CAD object to the PLM application via the CAD application based upon the data received from the PLM system.

In another embodiment, a computer-implemented method, includes: detecting an initiation of a save of a computer-aided design (CAD) object of a CAD application; determining whether a classification, attribute, or classification and attribute should be associated with the CAD object; when the classification, attribute, or classification and attribute should be associated with the CAD object; querying, via a classification customization integration module, including processor-readable instructions stored on a third tangible, non-transitory, machine readable medium, a product lifecycle management (PLM) system for data related to classification, attribute, or classification and attribute options available for a current user of the CAD application; receiving response data providing the data related to classification, attribute, or classification and attribute options available for the current user of the CAD application from the PLM system; and associating, via the classification customization integration module, the classification, attribute, or classification and attribute with the CAD object in the PLM system; and completing a check-in process of the CAD object in the CAD application.

In another embodiment, a tangible, non-transitory, machine-readable medium, includes machine readable instructions to: query a product lifecycle management (PLM) system for data related to classification, attribute, or classification and attribute options available for a current user of a computer-aided design (CAD) application; receive response data providing the data related to classification, attribute, or classification and attribute options available for the current user of the CAD application from the PLM system; provide an integrated dialog box in a graphical user interface (GUI) of the CAD application, wherein the dialog box includes classification, attribute, or classification and attribute selections based upon the response data; receive one or more selections from the classification, attribute, or classification and attribute selections; and associate a classification, attribute, or classification and attribute indicated by the one or more selections with a CAD object of the CAD application in the PLM system.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a block diagram illustrating a design system with a computer-aided design (CAD) system that is integrated with a classification system, in accordance with an embodiment;

FIG. 2 is a flowchart illustrating a process for classification and/or attribute association of the design system of FIG. 1, in accordance with an embodiment;

FIGS. 3A-3D are block diagrams illustrating a progression of integrated classification and/or attribute association with computer-aided design (CAD) objects (e.g., drawings, models, and/or assemblies), in accordance with an embodiment;

FIG. 4 is a flowchart illustrating a process for accessing computer-aided design (CAD) objects (e.g., drawings, models, and/or assemblies) based upon classification and/or attribute information associated with the CAD objects using the process of FIG. 2, in accordance with an embodiment; and

FIG. 5 is a block diagram illustrating a system for accessing files using the process of FIG. 4, in accordance with an embodiment.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

As noted above, product lifecycle management (PLM) systems oftentimes are used in conjunction with computer-aided design (CAD) systems, to facilitate collaboration and development of products for many industries. For example, manufacturers may use PLM systems to manage activities associated with CAD objects (e.g., CAD drawings, models, and/or assemblies) that are created and/or loaded into a CAD system.

Provided herein are techniques and systems for seamless integration of PLM system functionalities, such as classification and/or attribute association, to a CAD system. By providing a seamless integration between the CAD system and the PLM systems, several efficiencies may be obtained. For example, as will be explained in more detail below, CAD object attributes and/or classifications may be provided via a single graphical user interface (GUI), rather than processes that use multiple GUIs and/or applications to design and independently provide attributes and/or classifications. Further, by using the integrated systems and methods described herein, the classification and attribute association of CAD objects may occur in a decreased amount of time over systems using multiple GUIs and/or applications. For example, classification and/or attribute association may occur during and/or in near-real time as the CAD objects are being saved in the CAD system, as opposed to delayed classification and/or attribute association which may be caused by independent GUIs and/or applications. Additional access features may be provided based upon adding the classification and/or attributes during or near saving of the CAD objects. For example, in CAD systems that provide access to particular users based upon particular attributes and/or classifications of the CAD objects, the quicker classification and/or attribute association provided herein may allow for quicker access to the CAD objects based upon classification and/or particular attributes associated with the CAD objects.

### DETAILED DESCRIPTION

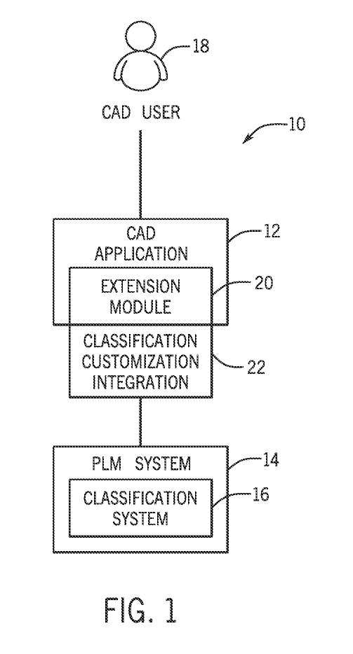

With the foregoing in mind, FIG. 1 is a block diagram illustrating a design system 10 with a computer-aided design (CAD) application 12 that is integrated with a product lifecycle management (PLM) system 14 that has a classification system 16, in accordance with an embodiment. A CAD user 18 may access the CAD application 12 to create and/or access one or more CAD objects (e.g., drawings, models, and/or assemblies) of the CAD application 12. For example, a CAD user 18 may be an engineer that designs gas turbine system components. The gas turbine component engineer may create two-dimensional drawings, three-dimensional models, and/or model assemblies using the CAD application 12.

The CAD application 12 may include an association module 20, which may allow customized functionalities to be implemented within the CAD application 12. In other words, one or more plug-in modules that include computer-readable instructions may be added to the CAD application 12 via the association module 20.

To facilitate seamless integration between the CAD application 12 and the PLM system 14, one or more plug-in modules may be incorporated into the system 10. For example, in the current embodiment, a classification customization integration plug-in 22 is incorporated into the CAD application 12 using the association module 20 of the CAD application 12.

The classification customization integration module 22 may provide functionalities of the PLM system 14 and/or an interface to use functionalities of the PLM system 14 via the CAD application 12. For example, the classification customization integration module 22 may poll the PLM system 14 for data associated with the classification 16 and provide a presentation of the data and/or other functionalities based upon the data to the CAD application 12. For example, available classifications, attributes, etc. of the PLM system 14 may be obtained by the classification customization integration module 22 by querying the PLM system 14.

In some embodiments, attributes of the CAD user 18 may be provided to the PLM system from the classification customization integration module 22, resulting in data that is available particularly for the current CAD user 18. In one embodiment, the classification customization integration module 22 may provide an identifier of the current CAD user 18 to the PLM system 14. The PLM system 14 may be set up to restrict certain functionalities from the current CAD user 18. For example, the CAD user 18 may be restricted from classifying a CAD object beyond and/or lower than a threshold classification level. Further, the CAD user 18 may be restricted from assigning certain attributes to the CAD objects. For example, if the CAD user 18 is a gas turbine engineer that is not authorized to work on a gasification system, the PLM system 14 may restrict any attribute association related to the gasification system. Accordingly, by providing the identifier of the CAD user 18, the PLM system 14 may filter response data for the particular current CAD user 18.

In some embodiments, alternative and/or additional filtering may occur in the classification customization integration module 22. For example, the classification customization integration module 22 may include filtering or other functionalities of response data provided by the PLM system 14 based upon the CAD user 18 identifier or other CAD user 18 attributes. For example, a work location of the CAD user 18 may result in filtering of available options in the classification customization integration module 22.

The classification customization integration module 22 may provide certain functionalities based upon this processed response data. For example, the classification customization integration module 22 may automatically associate certain attributes and/or classifications to a CAD object in the classification system 16 and/or may provide a graphical user interface to receive an indication of particular attributes and/or classifications that should be associated with the CAD object. Based upon the indications provided by the CAD user 18, the classification customization integration module 22 may automatically request that the proper classifications and/or attributes be associated with the CAD objects in the PLM system 14 and/or the classification system 16.

Accordingly, functionalities of the PLM system 14 and/or classification system 16 may be seamlessly integrated with the CAD application 12. Thus, the classification and attribute association of CAD objects may occur near instantaneously. For example, classification and/or attribute association may occur during and/or in near-real time as the CAD objects are being saved in the CAD system, as opposed to delaying classification and/or attribute association until the CAD user 18 independently accesses the PLM system 14. Thus, the attributes and/or classifications may be more readily applied to the CAD objects, resulting in more accuracy in classification and/or attribute association of the CAD objects, as well as quicker access of the CAD objects based upon the classification and/or attributes of the CAD objects.

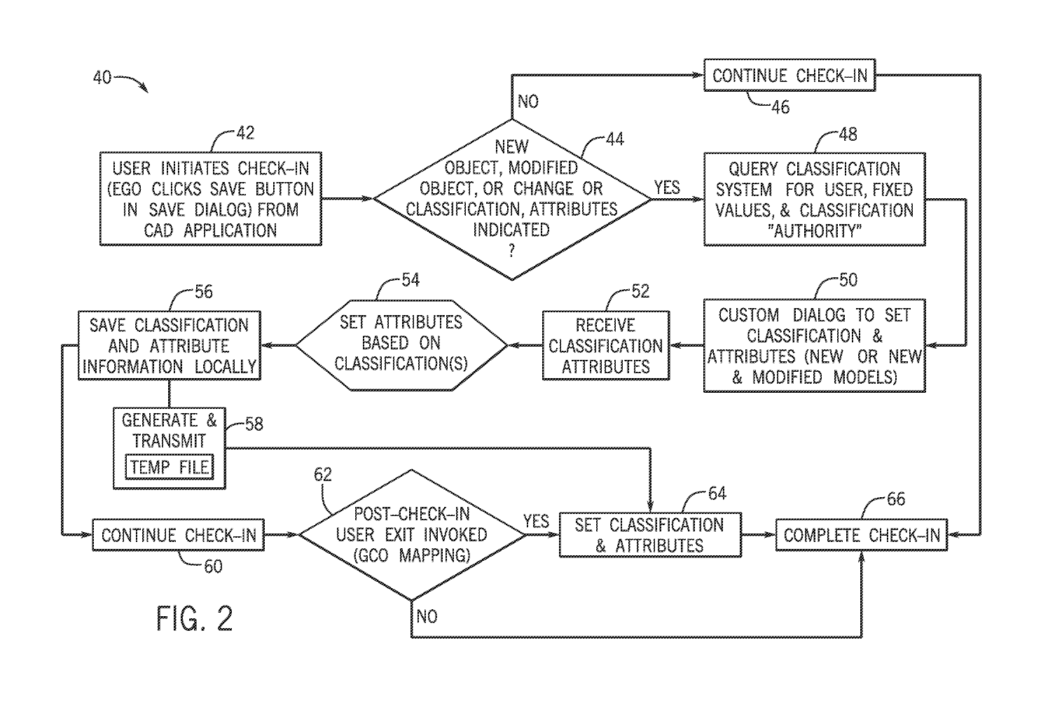

FIG. 2 is a flowchart illustrating a process 40 for classification and attribute association of the design system of FIG. 1, in accordance with an embodiment. As previously mentioned, the CAD user 18 may design and/or access CAD objects in the CAD application 12. Eventually, once the objects are ready to be saved to the system, the user 18 may “check-in” (e.g., save) the changes. In some embodiments, this check-in process may be initiated (block 42) by clicking a save icon in the CAD application 12.

Next, a pre-check-in process occurs (decision block 44), where a determination is made as to whether the object to be saved is a new object, a modified object, or an object where there has been an indication that a classification and/or attribute should be modified. For example, the user 18 may provide the indication that attributes and/or classifications of an already existing and/or unmodified object should be changed. If the object is not new, has not changed, and there is no indication that a classification and/or attribute should be changed, the check-in process may continue without further use of the classification and/or attribute integration functionality (block 46).

If the object is a new object, the object will not have any classifications and/or attributes associated with it. Further, classifications and/or attributes may change as drawings, models, and/or assemblies are modified. In some instances, a CAD user 18 may provide an explicit indication that a classification and/or attribute modification is necessary. Accordingly, classification and/or attribute association functionalities may be provided via the classification customization integration module 22.

Thus, next the classification customization integration module 22 may query the PLM system 14 and/or classification system 16 for data, such as user-specific data, fixed data, and/or other user-specific authority data for classification and/or attribute association (block 48). For example, as mentioned above, an identity of the CAD user may be provided to the PLM system 14 and/or classification system 16 to determine fixed classification and/or attributes that may be associated by all users as well as user-specific classification and/or attributes that are available for association by the specific CAD user 18.

The PLM system 14 and/or classification system 16 may respond with data representative of the fixed classification and/or attributes that may be associated by all users as well as user-specific classification and/or attributes that are available for association by the specific CAD user 18. Based upon this response data, classification and/or attribute association functionalities may be integrated with in the CAD application 12. For example, a custom dialog box may be provided to the CAD user 18 to set classification and attributes for the CAD object (block 50). In some embodiments, automatic association of particular classification and/or attributes may occur based upon CAD user attributes, attributes of the CAD application 12, and/or other factors.

In some embodiments, certain attributes (e.g., a classification, drawing criticality, export-control, etc.) of the CAD objects may be automatically set. For example, in situations where a user has reduced privileges for setting attributes, the system may automatically set the attributes. In embodiments where the dialog box is displayed, classification and/or attributes of the CAD objects may be set based upon the selections of the user in the dialog box (block 52).

In some embodiments, some attributes may be set based upon a previously set classification (block 54). For example, when a classification is set to a level that is not public, meaning not available for all users, an additional prompting for an indication of particular users that should have access to the object may be provided. Alternatively, in some embodiments, access may not be dependent on particular user access indications, but instead may provide access based upon the classification of the CAD objects and the classification levels available to the particular users requesting access.

Once all of the classification and/or attribute indications are received, the classification customization integration module 22 may save the classifications and/or attributes locally (block 56). Further, a temporary file is generated and provided to the PLM system 14 and/or classification system 16 (block 58).

Concurrently, the check-in process in the CAD application 12 continues in a similar fashion as block 46 (block 60). For example, write access is obtained for the CAD object and the object and/or object modifications are stored in the CAD application 12 storage location.

Further a post-check in process determines whether the classification and/or attributes are ready to be set in the PLM system 14 and/or classification system 16 (decision block 62). During the post-check in process, the system verifies that the CAD objects are correctly created and loaded for check in. This helps to ensure that no check in errors occurred prior to classifying the objects. If the classification and/or attributes are ready to be set in the PLM system 14 and/or classification system 16, the classification and/or attributes are set in the PLM system 14 and/or classification system 16 (block 64), otherwise the classification and/or attributes are not set. To set the classification and/or attributes, the temporary file that was transmitted in block 58 is used to determine what to set in the PLM system 14 and/or classification system 16. Then, regardless of whether or not the classification and/or attributes were set, the check-in completes (block 66).

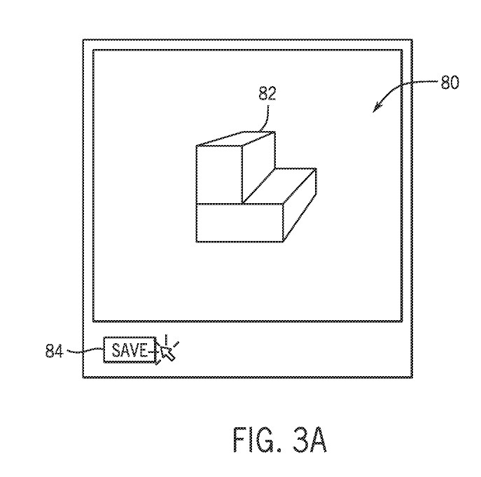

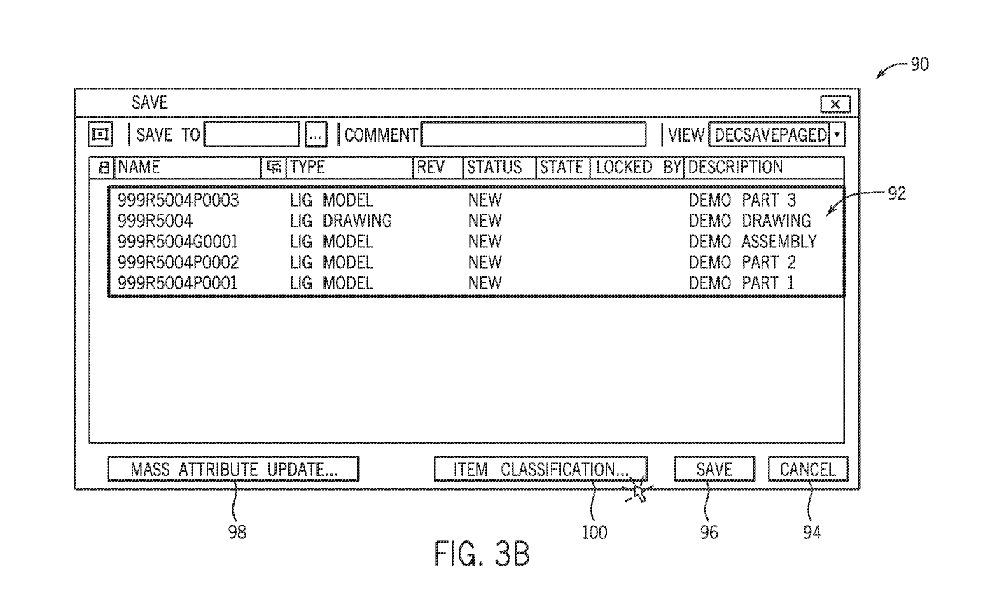

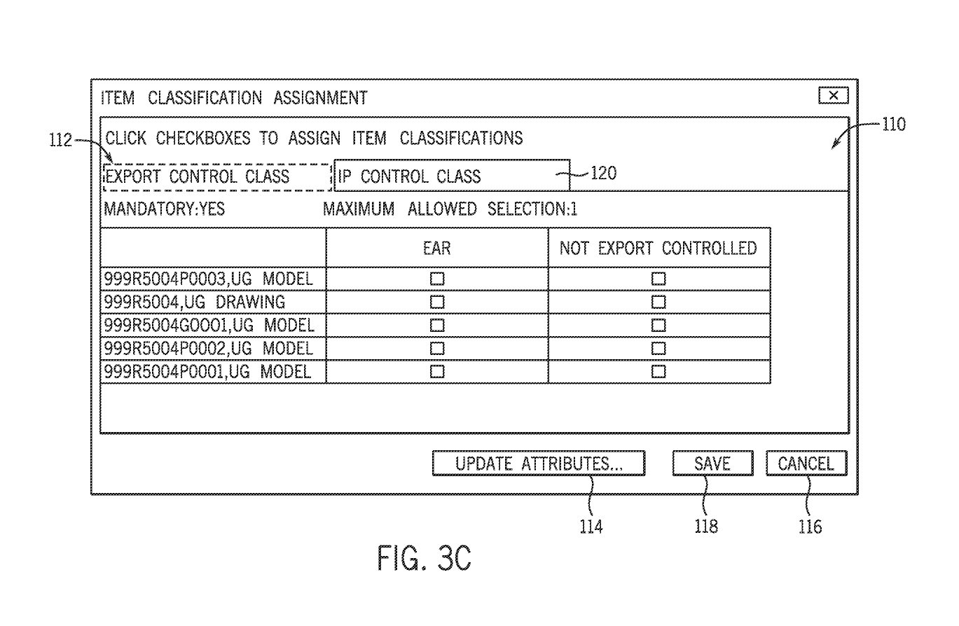

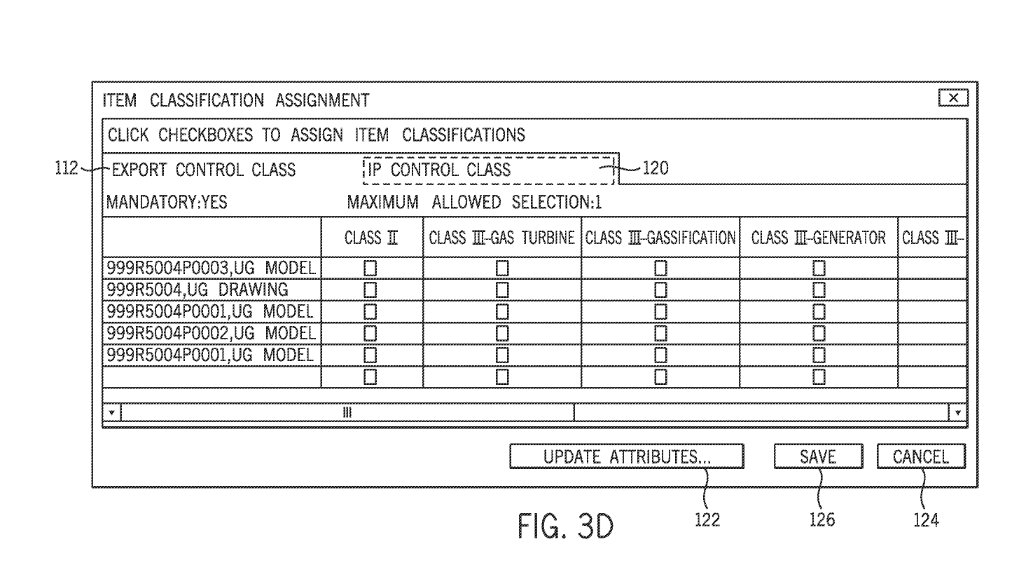

FIGS. 3A-3D are block diagrams illustrating a progression of integrated classification and/or attribute association of computer-aided design (CAD) objects (e.g., drawings, models, and/or assemblies), in accordance with an embodiment. In FIG. 3A a CAD GUI 80 is provided. As illustrated, a CAD object 82 (e.g., a CAD drawing, model, and/or assembly) is created using the GUI 80. Eventually, the CAD user may decide to save the object by clicking an appropriate check-in or save icon 84. Next, a save dialog box 90 is presented to the user, as depicted in FIG. 3B. The save dialog box 90 includes a listing 92 of the objects to be saved. The cancel icon 94 cancels the save without saving the changes to the CAD application. The save icon 96 saves the objects without associating a classification and/or attributes. A mass attribute update . . . icon 98 may allow a mass update of a particular attribute for all selected objects in the list 92. When the Item Classification . . . icon 100 is selected, an item classification dialog box 110 is presented to the user, as illustrated in FIG. 3C. In some embodiments, an export control classification tab 112 may be presented to the user. The export control classification may specify whether the particular CAD object is under Export Administration Regulations (EAR) or not. For example, for security concerns, the United States Department of Commerce has provided export regulations for items exported outside the United States. The export control classification tab 112 provides a particular interface for specifying whether or not particular CAD drawings, models, and/or assemblies are subject to EAR or not. As illustrated, the export control class tab 112 may include particular user requirements for classifying the CAD objects. For example, in the current embodiment, the indication “Mandatory: YES” indicates that a selection is required for each object being classified. Alternatively, an indication of “Mandatory: NO” indicates that a selection is not required. Because the objects are either subject to EAR or not, the “Maximum Allowed Selection: 1” indicates that only one selection may be made per object. EAR and NOT Export Controlled may not both be selected for the same CAD object.

Based upon the selections made in the export control class tab, additional attributes may be updated by selecting the Update Attributes . . . icon 114. For example, particular text, such as legal language may be attributed to the object based upon the classification being subject to EAR and/or Not Export Control (NEC) classifications. Further, classification updates may be cancelled without saving by selecting the Cancel icon 116 or may be saved by selecting the Submit icon 118. In some embodiments, one or more additional icons may be present to continue the check in process after the attributes are updated.

Additional and/or alternative classification tabs may be provided. For example, an IP control class tab 120 may be provided. Upon selection of this tab 120, the dialog box may dynamically display alternative classification criteria related to tab 120, as illustrated in FIG. 3D. For example, particular access classes ranging from class I (publicly available) to class III (restricted internal access) that are available to the current user may be displayed. In the current embodiment, class II and class III classifications are provided to a user that has authority to classify objects in a class II or greater classification. Because the user does not have access to class I classification, class I options are not provided to the user. As with the export control class tab 112 of FIG. 3C, a single selection is allowed and a selection is mandatory. Further, as illustrated, multiple classifications within a particular class may also be provided. For example, a particular applicable system (e.g., gas turbine, gasification, and/or generator) of an overarching system (e.g., gas turbine plant) may be provided, to enable more granular classification of the objects. As with the export control class tab 112, attributes derived from the particular selected classifications may be updated using the Update Attributes . . . icon 122. The classification updates may be cancelled using the cancel icon 124 and/or may be submitted for incorporation at the PLM system 14 and/or classification system 16 by selecting the submit icon 126.

As may be appreciated, the integration of classification and/or attribute association at the time of saving CAD objects is highly useful. For example, without this integration, CAD users oftentimes forget to access the PLM system 14 to classify their newly created objects. This may result in an inability to access these objects, even by the object creators, because access to objects without a classification may be locked out after a certain period of time.

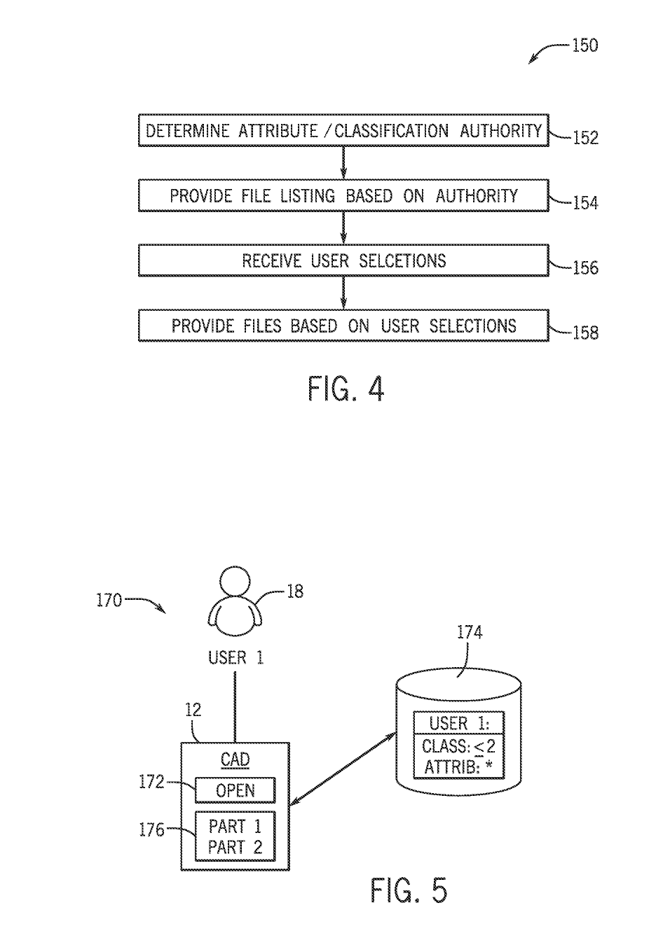

FIG. 4 is a flowchart illustrating a process 150 for accessing computer-aided design (CAD) objects (e.g., drawings, models, and/or assemblies) based upon classification and/or attribute information associated with the CAD objects using the process of FIG. 2, in accordance with an embodiment. FIG. 5 is a block diagram illustrating a system 170 for accessing files using the process of FIG. 4, in accordance with an embodiment. Because FIGS. 4 and 5 are inter-related, they will be discussed together.

As discussed above, access to one or more objects of the CAD application 12 may be restricted based upon certain classifications and/or attributes that have been associated with the object. By implementing classification and/or attribute association in the CAD application 12 at the time the object is saved, access based upon these classification and/or attribute associations may occur without a delay that has traditionally been used to allow the user to independently access the PLM system 14 and/or classification system 16 to set these classifications and/or attributes. Thus, the process 150 may occur without such a delay when the classification and/or attributes are associated with the CAD objects in the integrated manner provided herein.

From time to time, the CAD user 18 may desire to access one or more CAD objects from the CAD application 12. To do this, the user 18 may access a function to open a CAD object (e.g., via an Open icon 172. Upon receiving an indication that the user 18 desires to access one or more CAD objects, the process 150 may commence.

The process 150 begins by determining attribute and/or classification authority for the user 18 (block 152). For example, particular access rights for the CAD objects may be obtained as well as the authority attributes for the user 18. In one example, when the user 18 has authority to view and/or modify objects that have a classification of II or lower (as illustrated in the rules/authority database 174, the user 18 does not have access rights to view and/or modify objects with a classification of III.

Further, attribute access rules may also be enforced upon a user's access authority. In the illustrated embodiment of FIG. 5, “Attrib: *” in the rules/authority database 174 indicates that user 18's access is not dependent upon particular attribute rules associated with the object. Thus, regardless of attributes associated with the objects, user 18 may access all objects with a classification of II or less. For simplicity, a classification number is the only provided classification that determines access authority. However, in practice, any number of classification variables, user attributes, CAD system attributes, object attributes, etc. may be employed to determine object access. For example, objects with an EAR classification may not be accessible to users and/or systems outside of the United States. Any number of authority rules may be generated based upon the available data.

Once the authority rights are determined, a file listing is provided based upon the authority (block 154). For example, going back to user 18's access rights based upon a classification of II or lower, a list of objects 176 satisfying those classification requirements may be provided to the user 18 (e.g., via the CAD application 12).

Upon receiving the selections, the user 18 may provide selections of objects to access, which are received (block 156). Based upon the received selections, the CAD application 12 may provide access to the objects (block 158).

As may be appreciated, classification and/or attribute access rules may be enforced in a more timely manner with higher precision using the integrated association techniques and systems described herein. Accordingly, security, management, and execution of CAD projects may be enhanced, resulting in more efficient use of resources and quicker project turnaround.

Technical effects of the invention include seamless integration of PLM system functionalities, such as classification and/or attribute association, to a CAD system. By providing a seamless integration between the CAD system and the PLM systems, several efficiencies may be obtained. For example, despite CAD systems and PLM systems being independent, CAD object attributes and/or classification associations may be provided via a single graphical user interface (GUI), rather than processes that use multiple GUIs and/or applications to design and independently provide attributes and/or classifications. Further, by using the integrated classification and/or attribute association systems and methods described herein, the classification and attribute association of CAD objects may occur in a decreased amount of time over systems using multiple GUIs and/or applications. For example, classification and/or attribute association may occur concurrently with the save process of the CAD objects, as opposed to delayed classification and/or attribute association which may be caused by independent GUIs and/or applications. Thus, additional access features may be subsequently implemented using the timely classification and/or attribute associations. For example, in CAD systems that provide access to particular users based upon particular attributes and/or classifications of the CAD objects, the timely classification and/or attribute association provided herein allows for quicker implementation of access rules based upon these classification and/or particular attributes associations with the CAD objects.

This written description uses examples to disclose the embodiments, including the best mode, and also to enable any person skilled in the art to practice the invention, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A system comprising:
a computer-aided design (CAD) system, comprising:
a first processor, configured to execute a CAD application, wherein the CAD application comprises processor-readable instructions stored on a first tangible, non-transitory, machine readable medium;
a product lifecycle management (PLM) system, comprising:
a second processor, configured to execute a PLM application, wherein the PLM application comprises processor-readable instructions stored on a second tangible, non-transitory, machine readable medium; and
a classification customization integration module, comprising processor-readable instructions stored on a third tangible, non-transitory, machine readable medium, wherein the classification customization integration module is configured to:
receive data from the PLM application; and
provide classification, attribute, or classification and attribute associations with a CAD object to the PLM application via the CAD application based upon the data received from the PLM system.

2. The system of claim 1, wherein:
the first processor, the second processor, and the third processor are all the same.

3. The system of claim 1, wherein the classification customization integration module is configured to provide one or more dialog boxes in a graphical user interface (GUI) of the CAD application based upon the data received the PLM application, wherein the one or more dialog boxes comprise classification, attribute, or classification and attribute selections for subsequent association with the CAD object.

4. The system of claim 3, wherein the one or more dialog boxes comprise export control classifications comprising an indication of whether or not the CAD object is subject to Export Administration Regulations (EAR).

5. The system of claim 3, wherein the one or more dialog boxes comprise IP control classifications comprising an indication of access rights for the CAD object.

6. The system of claim 5, wherein the access rights comprise levels of access rights, comprising: public access and restricted internal access.

7. The system of claim 3, wherein the one or more dialog boxes comprise an indication of a particular system of an over-arching system that the CAD object belongs to.

8. The system of claim 3, wherein the one or more dialog boxes comprise a sub-dialog box that provides attributes that may be updated based upon an indication of a selected classification in the one or more dialog boxes.

9. The system of claim 1, wherein the CAD application is configured to access the CAD object based upon at least one classification, attribute, or classification and attribute rule after the classification, attribute, or classification and attribute associations are provided to the PLM application.

10. The system of claim 1, wherein:
the CAD application comprises an extension module configured to accept customization plug-ins to be run in the CAD application; and
the classification customization integration module comprises a plug-in configured to work with the extension module.

11. A computer-implemented method, comprising:
detecting an initiation of a save of a computer-aided design (CAD) object of a CAD application;
determining whether a classification, attribute, or classification and attribute should be associated with the CAD object;
when the classification, attribute, or classification and attribute should be associated with the CAD object:
querying, via a classification customization integration module, comprising processor-readable instructions stored on a third tangible, non-transitory, machine readable medium, a product lifecycle management (PLM) system for data related to classification, attribute, or classification and attribute options available for a current user of the CAD application;
receiving response data providing the data related to classification, attribute, or classification and attribute options available for the current user of the CAD application from the PLM system; and
associating, via the classification customization integration module, the classification, attribute, or classification and attribute with the CAD object in the PLM system; and
completing a check-in process of the CAD object in the CAD application.

12. The computer-implemented method of claim 11, comprising:
generating a temporary file indicating associations to be made in the PLM system;
transmitting the temporary file to the PLM system; and
associating, in accordance with the temporary file, the classification, attribute, or classification and attribute with the CAD object in the PLM system after the CAD object is transferred to PLM system.

13. The computer-implemented method of claim 11, wherein the classification customization integration module is configured to:
providing an integrated dialog box in a graphical user interface (GUI) of the CAD application, wherein the dialog box comprises classification, attribute, or classification and attribute selections based upon the response data.

14. The computer-implemented method of claim 13, wherein the dialog box comprises export control classifications comprising an indication of whether or not the CAD object is subject to Export Administration Regulations (EAR).

15. The computer-implemented method of claim 13, wherein the dialog box comprises IP control classifications comprising an indication of access rights for the CAD object.

16. The computer-implemented method of claim 13, wherein the dialog box comprises an indication of a particular system of an over-arching system that the CAD object belongs to.

17. The system of claim 13, wherein the dialog box comprises a sub-dialog box that provides attributes that may be updated based upon an indication of a selected classification in the dialog box.

18. A tangible, non-transitory, machine-readable medium, comprising machine readable instructions to:
query a product lifecycle management (PLM) system for data related to classification, attribute, or classification and attribute options available for a current user of a computer-aided design (CAD) application;
receive response data providing the data related to classification, attribute, or classification and attribute options available for the current user of the CAD application from the PLM system;
provide an integrated dialog box in a graphical user interface (GUI) of the CAD application, wherein the dialog box comprises classification, attribute, or classification and attribute selections based upon the response data;
receive one or more selections from the classification, attribute, or classification and attribute selections; and
associate a classification, attribute, or classification and attribute indicated by the one or more selections with a CAD object of the CAD application in the PLM system.

19. The tangible, non-transitory, machine-readable medium of claim 18, wherein the dialog box comprises export control classifications comprising an indication of whether or not the CAD object is subject to Export Administration Regulations (EAR).

20. The tangible, non-transitory, machine-readable medium of claim 18, wherein the dialog box comprises IP control classifications comprising an indication of access rights for the CAD object.
